(19) United States
(12) Patent Application Publication
(10) Pub. No.: US 2025/0199494 A1
(43) Pub. Date: Jun. 19, 2025

(54) INFORMATION PROCESSING METHOD, INFORMATION PROCESSING APPARATUS, PROGRAM FOR CONTROLLING OPERATION OF APPLIANCE

(71) Applicant: Panasonic Intellectual Property Corporation of America, Torrance, CA (US)

(72) Inventors: Kentaro MURATA, Osaka (JP); Saeko SHINGU, Osaka (JP); Kenta MURAKAMI, Osaka (JP)

(73) Assignee: Panasonic Intellectual Property Corporation of America, Torrance, CA (US)

(21) Appl. No.: 19/071,966

(22) Filed: Mar. 6, 2025

Related U.S. Application Data
(63) Continuation of application No. PCT/JP2023/029814, filed on Aug. 18, 2023.

(30) Foreign Application Priority Data
Sep. 20, 2022 (JP) 2022-149441

(51) Int. Cl. G05B 15/02

(52) U.S. Cl. CPC G05B 15/02

(57) ABSTRACT

A first acquisition unit acquires, as a first block sequence, a block sequence comprised of a plurality of blocks each defined in a functional unit executable by an appliance and arranged in an order of operation, the block sequence being scheduled to be executed by the appliance. A second acquisition unit acquires action information indicating a detail of action executed by a user in the appliance. An output unit outputs a second block sequence created by modifying or deleting a block included in the first block sequence and not matching the action information.

This application is based upon and claims the benefit of priority from the prior Japanese Patent Application No. 2022-149441, filed on Sep. 20, 2022, the entire contents of which are incorporated herein by reference.

### BACKGROUND

### 1. Field

The present disclosure relates to information processing technology and, particularly, to an information processing method, an information processing apparatus, and a program for controlling an operation of an appliance.

### 2. Description of the Related Art

Even if the condition of a washing machine changes after the washing machine is reserved, it is desired to realize an operation intended by the user. When the weight of the clothing in the washing machine or the operating condition changes while the user is out, etc., requiring a change in the detail of reservation needs, control information in which the detail of reservation is changed is transmitted to the washing machine (see, for example, Patent Literature 1).

[Patent Literature 1] JP 2020-103871

According to Patent Literature 1, the detail of reservation is changed, and control information is transmitted to the washing machine, based on a change in the weight of the clothing in the washing machine and the operating condition. However, information used to determine the need for a change in the detail of reservation is the weight of the clothing or the operating condition, and a specific user action such as what type of clothing the user has input in is not considered.

### SUMMARY

The present disclosure addresses the issue described above, and a purpose thereof is to provide a technology of modifying a step when a result different from the result expected at the end of the step could be produced due to an action taken by the user.

An information processing method according to an embodiment of the present disclosure includes: acquiring, as a first block sequence, a block sequence comprised of a plurality of blocks each defined in a functional unit executable by an appliance and arranged in an order of operation, the block sequence being scheduled to be executed by the appliance; acquiring action information indicating a detail of action executed by a user in the appliance; and outputting a second block sequence created by modifying or deleting a block included in the first block sequence and not matching the action information.

Another embodiment of the present disclosure relates to an information processing apparatus. The apparatus includes: a first acquisition unit that acquires, as a first block sequence, a block sequence comprised of a plurality of blocks each defined in a functional unit executable by an appliance and arranged in an order of operation, the block sequence being scheduled to be executed by the appliance; a second acquisition unit that acquires action information indicating a detail of action executed by a user in the appliance; and an output unit that outputs a second block sequence created by modifying or deleting a block included in the first block sequence and not matching the action information.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A-1G show shows a configuration of an appliance control system according to the embodiment;

FIGS. 2A-2E show a configuration of the functional block used in the appliance control system of FIGS. 1A-1G;

FIGS. 3A-3H show a configuration of the functional block sequence used in the appliance control system of FIGS. 1A-1G;

FIG. 4 shows an overview of the operation of the appliance of FIGS. 1A-1G;

FIG. 5 shows a configuration of the information processing system according to the embodiment;

FIG. 6 shows a configuration of the information processing apparatus of FIG. 5;

FIG. 7 shows a data structure of a functional block sequence stored in the block DB of FIG. 6;

FIG. 8 shows a data structure of the rule information DB of FIG. 6;

FIG. 9 shows another data structure of the rule information DB of FIG. 6;

FIG. 10 shows an overview of a process executed by the first acquisition unit of FIG. 6;

FIG. 11 shows an overview of a process executed by the first processing unit of FIG. 6;

FIG. 12 is a sequence chart showing a sequence of steps for modifying a functional block sequence executed by the information processing system of FIG. 5;

FIG. 13 is a flowchart showing a sequence of steps for modifying a functional block sequence executed by the information processing apparatus of FIG. 6;

FIG. 14 shows an overview of a process executed by the first processing unit according to variation 1;

FIG. 15 shows a configuration of the functional block sequence according to variation 2; and

FIG. 16 shows a data structure of a table stored in the storage unit according to variation 3.

### DETAILED DESCRIPTION

The invention will now be described by reference to the preferred embodiments. This does not intend to limit the scope of the present invention, but to exemplify the invention.

All of the embodiments described below illustrate preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features illustrated in the figures are denoted by identical symbols, and a duplicate description is omitted or simplified. Hereinafter, the embodiment is described in the order of: (1) overview of functional block and functional block sequence and (2) modification of functional block sequence.

### (1) Overview of Functional Block and Functional Block Sequence

In household electrical/mechanical utensils such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

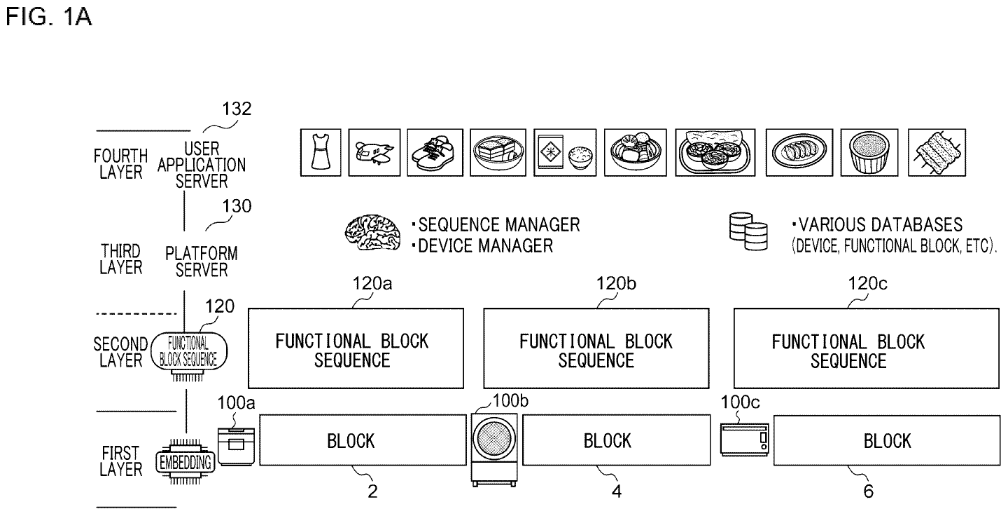

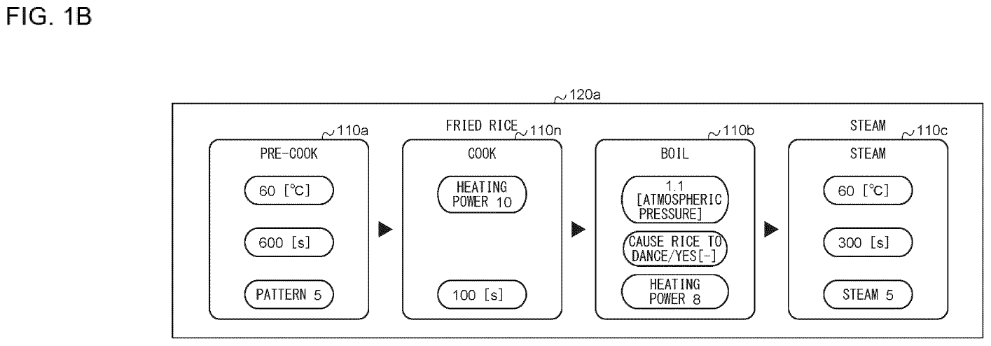

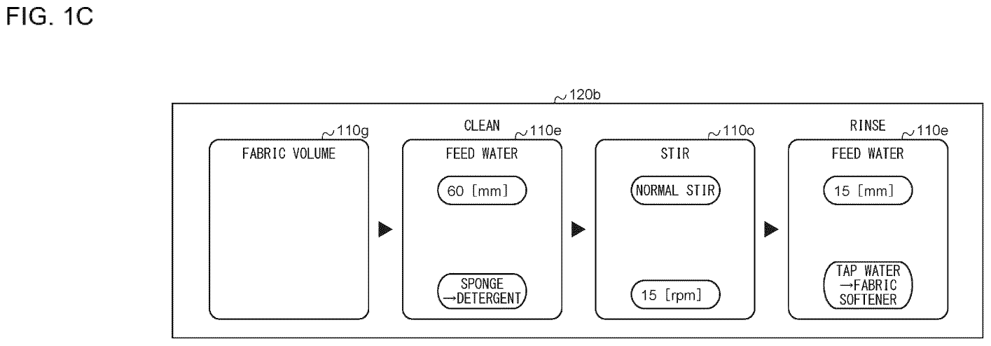

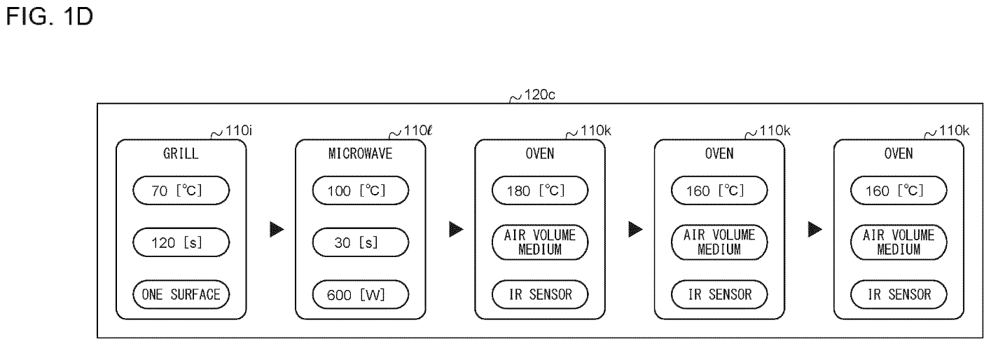

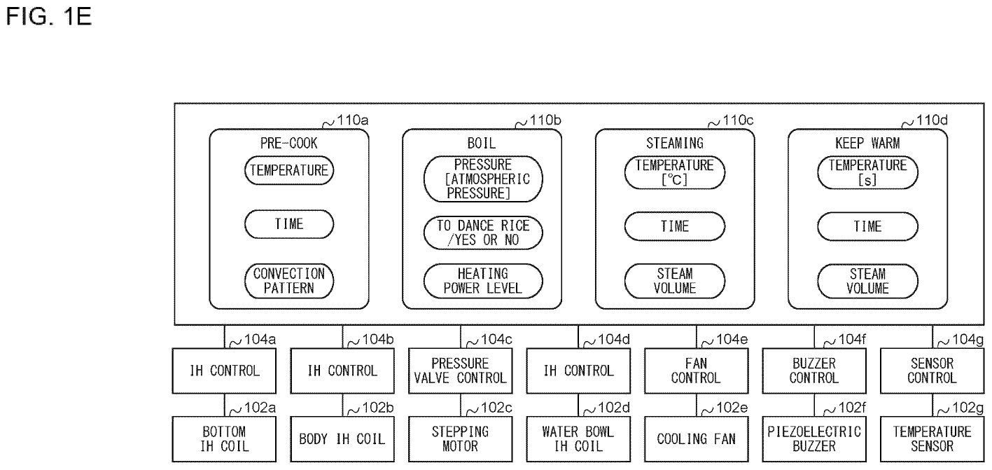

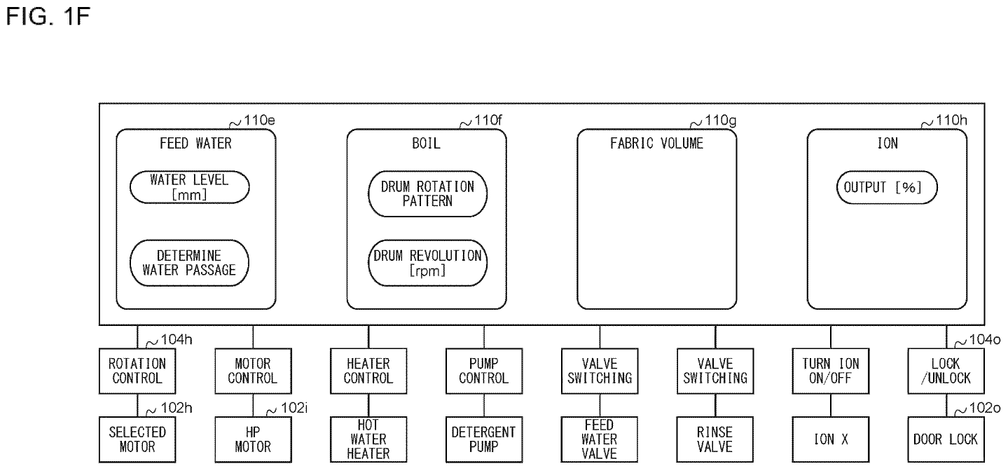

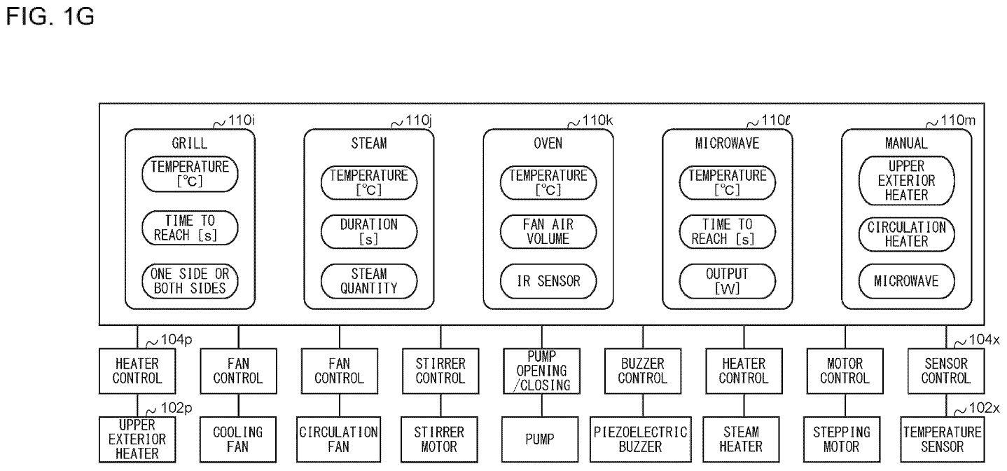

FIGS. 1A-1G show a configuration of an information processing system 1000. In the information processing system 1000, a four-layer model composed of the first to fourth layers is defined. In the first layer, the configuration of an appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 1E), a block 4 (FIG. 1F), a block 6 (FIG. 1G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device, and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102F) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 comprised of an arrangement of one or more functional blocks 110 in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 1B) is used in the rice cooker (appliance 100a), the functional block sequence 120b (FIG. 1C) is used in the washing machine (appliance 100b), and the functional block sequence 120c (FIG. 1D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the information processing system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the information processing system 1000 may be integrated. In that process, the platform server 130 and the user application server 132 are integrally configured. Alternatively, the third and fourth layers in the information processing system 1000 may be arranged in the same layer. Alternatively, the third and fourth layers in the information processing system 1000 may be omitted. In that process, the functional block sequence 120 is downloaded to the appliance 100 from the user apparatus (not shown) owned by the user.

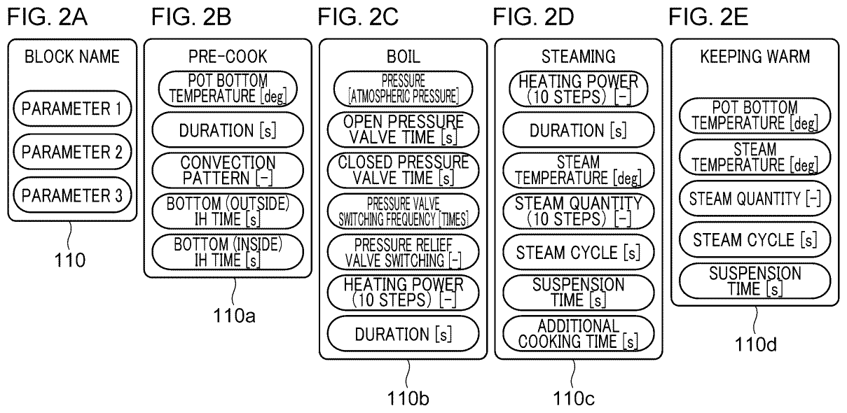

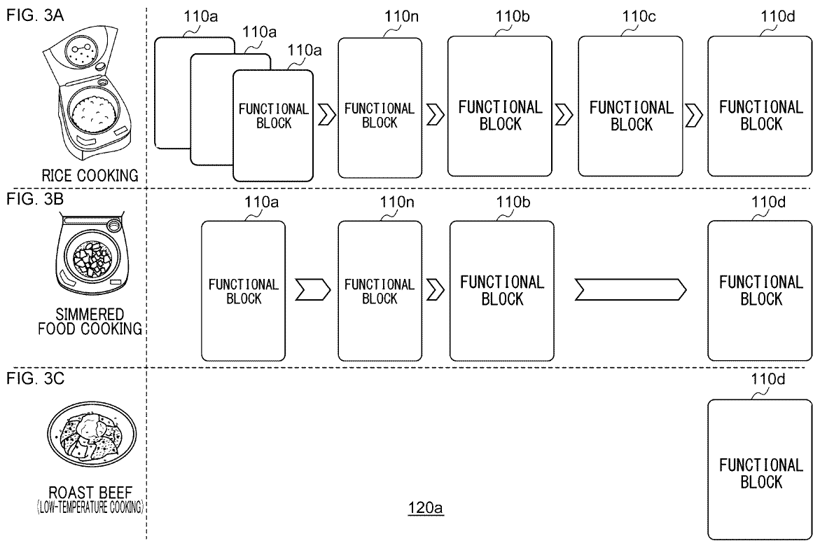

FIGS. 2A-2E show a configuration of the functional block 110 used in the information processing system 1000. FIG. 2A shows the basic configuration of the functional block 110. The functional block 110 is defined in a functional unit executable by the appliance 100 and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

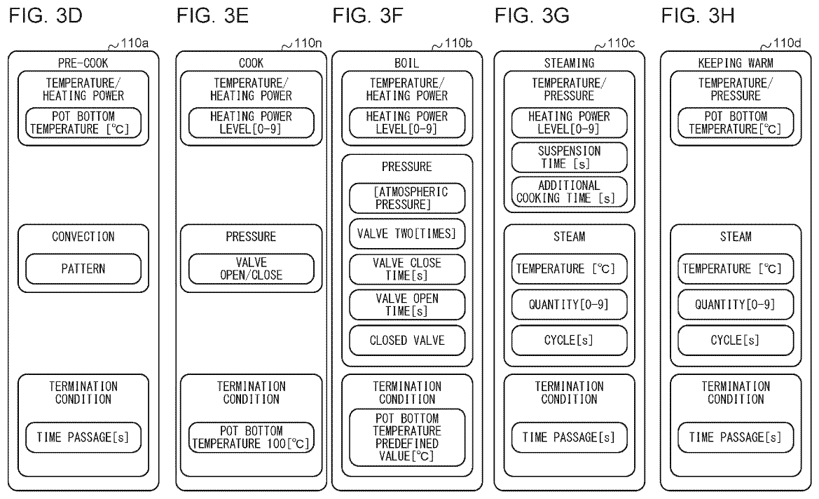

FIGS. 3A-3H show a configuration of the functional block sequence 120 used in the information processing system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking)”. The same applies to the functional block sequence 120 in the washing machine (appliance 100b) and the microwave oven (appliance 100c) of FIG. 1A.

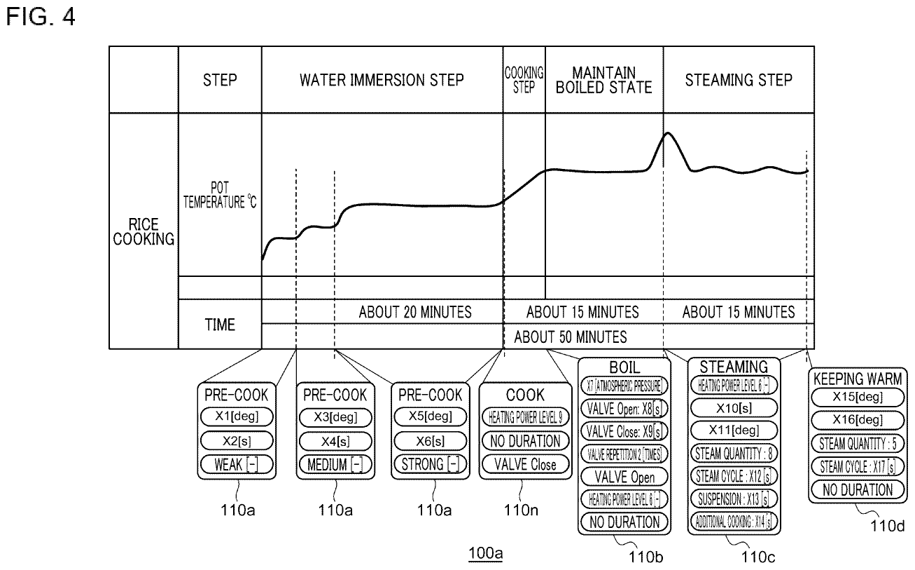

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

### (2) Modification of Functional Block Sequence

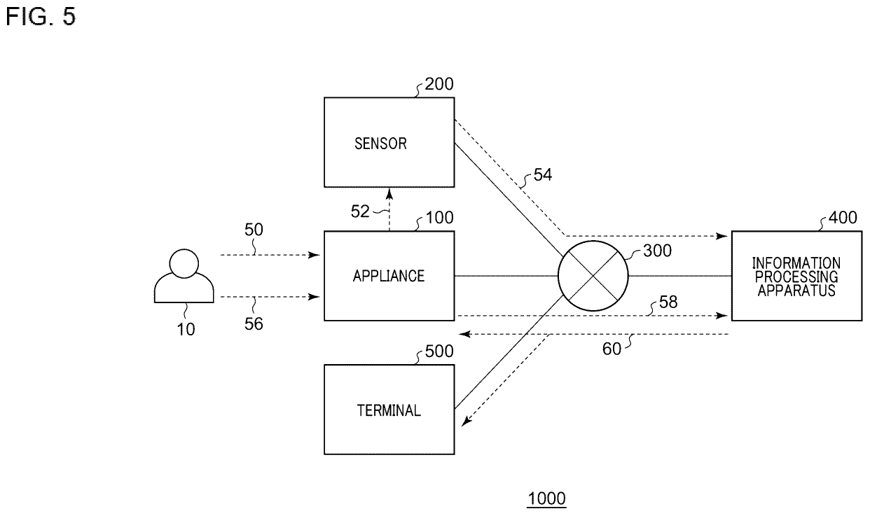

FIG. 5 shows a configuration of the information processing system 1000. The information processing system 1000 includes an appliance 100, a sensor 200, a network 300, an information processing apparatus 400, and a terminal 500. The appliance 100, the sensor 200, the information processing apparatus 400, and the terminal 500 are connected via the network 300 such as the Internet. The information processing system 1000 modifies a step in the case the quality of a finished product after the end of the step is deteriorates due to an action taken by the user. The number of appliances 100, sensors 200, and terminals 500 included in the information processing system 1000 is not limited to “1”.

The appliance 100 is a household electrical/mechanical appliance such as a washing machine, a rice cooker, a microwave oven, and an automatic cooking appliance. The appliance 100 is used by a user 10. The user 10 inputs a consumer product such as a cooking ingredient and clothing to the appliance 100 and sets a step such as a cooking step or a washing step in the appliance 100. The appliance 100 executes cooking or washing by operating according to the cooking step or the washing step. However, the user 10 may perform an action contradictory to the cooking step or the washing step scheduled to be executed such as making a mistake in the timing of inputting an ingredient or putting a sweater into the washing machine. A contradictory action like this is often found in beginners who are not accustomed to doing housework, and it is difficult to expect the user 10 himself or herself to recreate the cooking step or the washing step on the user's initiative, i.e., to expect the user 10 himself or herself to modify the step.

A purpose of the information processing system 1000 according to this embodiment is to modify a step in such a situation. The user 10 performs consumer product input 50 to the appliance 100. In the case the appliance 100 is a washing machine, the consumer product is a clothing, sweater, etc. In the case the appliance 100 is a cooking appliance, the consumer product is a cooking ingredient or a seasoning. The sensor 200 is, for example, an imaging apparatus such as a camera and is provided at a position where the consumer product input to the appliance 100 can be imaged. The sensor 200 may be provided outside the appliance 100 or mounted inside the appliance 100. The sensor 200 generates a movie or a still image (hereinafter, collectively referred to as an “image”) by executing consumer product imaging 52 in or around the appliance 100. For example, the sensor 200 captures an image so that the consumer product input by the user 10 to a washing machine, a pot or a frying pan on a stove, etc. can be identified. The sensor 200 has a communication function and is connected to the information processing apparatus 400 via the network 300. The sensor 200 transmits the captured image as sensor information 54 to the information processing apparatus 400 via the network 300. Alternatively, the sensor 200 may capture a video and transmit it to the information processing apparatus 400. Further, the sensor 200 may subjects the captured image to an image recognition process and may, as a result, acquire, for example, a character string such as sweater included in the image as meter data. In that process, the sensor 200 transmits the sensor information 54 including the metadata to the information processing apparatus 400 via the network 300.

The appliance 100 receives user control 56 from the user 10. The user control 56 received by the appliance 100 is for selecting one of a plurality of courses (menus) available for the cooking step or the washing step. For example, a plurality of courses such as a “recommended course” and “stylish clothing course” are available for the washing step. These courses are realized by the functional block sequence described later. The appliance 100 has a communication function and is connected to the information processing apparatus 400 via the network 300. The appliance 100 transmits the detail of the user control 56 initiated by the user 10, such as identification information on the functional block sequence, to the information processing apparatus 400 as user control information 58.

The information processing apparatus 400 is an apparatus having a communication function that can be connected to the network 300 and is, for example, a computer such as a server and a cloud server equipped with a processor, a memory, etc. The information processing apparatus 400 receives the sensor information 54 from the sensor 200 via the network 300 and receives the user control information 58 from the appliance 100. The information processing apparatus 400 determines whether the detail of action of the user 10 recognized by referring to the sensor information 54 matches the operation of the appliance 100 indicated by the user control information 58, i.e., the detail of the functional block sequence. When the detail of action of the user 10 matches the functional block sequence, the information processing apparatus 400 causes the appliance 100 to execute the operation indicated by the user control information 58. When the detail of action of the user 10 does not match the functional block sequence, on the other hand, the information processing apparatus 400 modifies the functional block sequence. Details of the process in the information processing apparatus 400 will be described later. The information processing apparatus 400 transmits information on the modified functional block sequence to the appliance 100 or the terminal 500 via the network 300 as suggested modification information 60.

The appliance 100 receives the suggested modification information 60 from the information processing apparatus 400 via the network 300. The appliance 100 includes a display unit (not shown) such as a display and displays the detail of the suggested modification information 60, i.e., the detail of the modified functional block sequence, on the display unit. The user 10 checks the detail of the screen displayed on the display unit and inputs an instruction for execution of the modified functional block sequence. The appliance 100 executes an operation according to the modified functional block sequence in accordance with the instruction input by the user 10. Alternatively, the appliance 100 may execute an operation according to the modified functional block sequence without displaying the detail of the suggested modification information 60 on the display unit. Still alternatively, the detail of the suggested modification information 60 may be displayed on the terminal 500 instead of the appliance 100 if the appliance 100 does not include a display unit.

The terminal 500 is an apparatus having a communication function that can be connected to the network 300 and is used by the user. The terminal 500 is, for example, a computer, a smartphone, or a tablet terminal. The terminal 500 includes a user control unit (not shown) such as a button that can receive information input by the user and a display unit (not shown) such as a display that can display information to the user. The user control unit and the display unit may be integrated as a touch panel. When the terminal 500 receives the suggested modification information 60 from the information processing apparatus 400 via the network 300, the terminal 500 displays the detail of the suggested modification information 60, i.e., the detail of the modified functional block sequence on the display unit.

The user 10 checks the detail of the screen displayed on the display unit and inputs an instruction for execution of the modified functional block sequence using the user control unit. The terminal 500 transmits information (hereinafter referred to as “instruction information”) showing an instruction for execution of the modified functional block sequence to the appliance 100 via the network 300 or to the appliance 100 via the network 300, the information processing apparatus 400, and the network 300. The appliance 100 executes an operation according to the modified functional block sequence in accordance with the received instruction information. In the description so far, the appliance 100 receives the user control 56 from the user 10 and transmits the user control information 58 to the information processing apparatus 400. However, the terminal 500 may receive user control from the user 10 and transmit the user control information 58 to the appliance 100 and the information processing apparatus 400. Alternatively, an operation according to the modified functional block sequence may be executed without the detail of the suggested modification information 60 being displayed in the appliance 100 and the terminal 500.

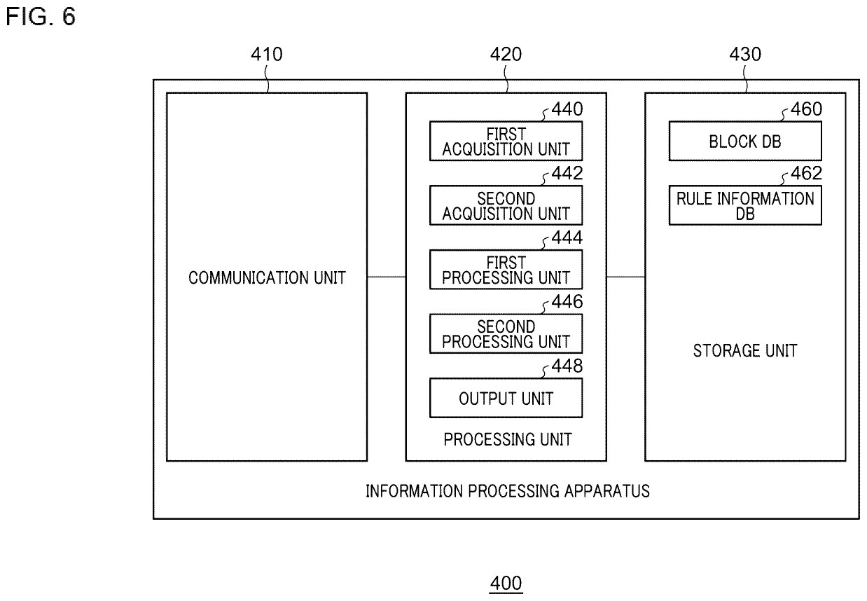

FIG. 6 shows a configuration of the information processing apparatus 400. The information processing apparatus 400 includes a communication unit 410, a processing unit 420, and a storage unit 430. The processing unit 420 includes a first acquisition unit 440, a second acquisition unit 442, a first processing unit 444, a second processing unit 446, and an output unit 448, and the storage unit 430 includes a block DB 460 and a rule information DB 462.

The storage unit 430 is, for example, an HDD (Hard Disk Drive) or an SSD (Solid State Drive) and can store electronic information. The block DB 460 stores the appliance 100 or the functional block sequence 120.

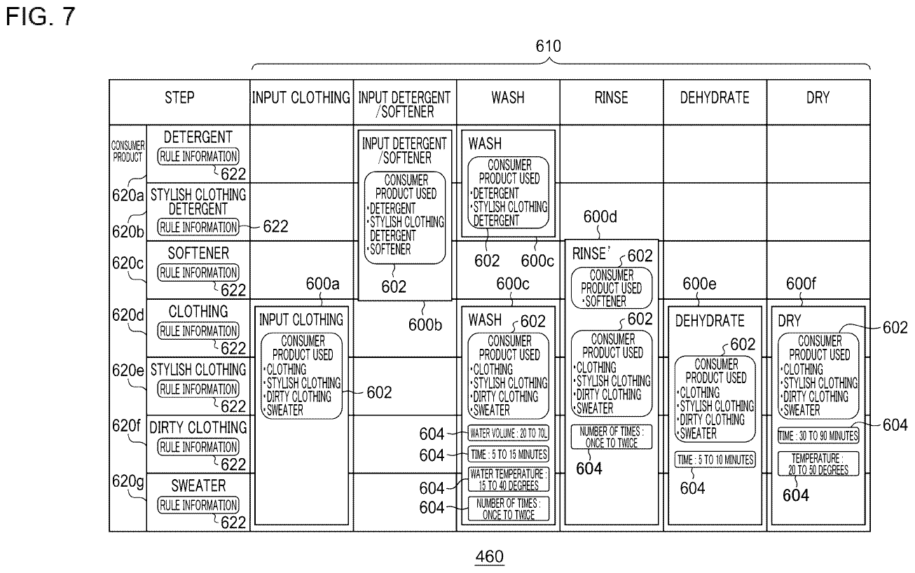

FIG. 7 shows a data structure of a functional block sequence 610 stored in the block DB 460. The figure shows the functional block sequence 610 used in a washing machine by way of one example. In the functional block sequence 610, a first functional block 600a to a sixth functional block 600f, collectively referred to as the functional block 600, are arranged in this order. The functional block 600 and the functional block sequence 610 correspond to the functional block 110 and the functional block sequence 120 described above. The first functional block 600a is an API related to the “input clothing” function, the second functional block 600b is an API related to the “input detergent/softener” function, and the third functional block 600c is an API related to the “wash” function. Further, the fourth functional block 600d is an API related to the “rinse” function, the fifth functional block 600e is an API related to the “dehydrate” function, and the sixth functional block 600f is an API related to the “dry” function.

A first consumer product 620a to a seventh consumer product 620g are shown as consumer products 620 that can be used in the functional block sequence 610. The first consumer product 620a is “detergent”, the second consumer product 620b is “stylish clothing detergent”, and the third consumer product 620c is “softener”. The fourth consumer product 620d is “clothing”, the fifth consumer product 620e is “stylish clothing”, the sixth consumer product 620f is “dirty clothing”, and the seventh consumer product 620g is “sweater”.

A consumer product used 602 or a parameter 604 can be set in each functional block 600. For example, a clothing, stylish clothing, dirty clothing, and sweater can be set as the consumer product used 602 in the first functional block 600a “input clothing”. A detergent, stylish clothing detergent, and softener can be set as the consumer product used 602 in the second functional block 600b “input detergent/softener”. A detergent, stylish clothing detergent, clothing, stylish clothing, dirty clothing, and sweater can be set as the consumer product used 602, and the water volume, time, water temperature, and number of times can be set as the parameter 604 in the third functional block 600c “wash”.

A softener, clothing, stylish clothing, dirty clothing, and sweater can be set as the consumer products used 602, and the number of times can be set as the parameter 604 in the fourth functional block 600d “rinse”. A clothing, stylish clothing, dirty clothing, and sweater can be set as the consumer products used 602, and the time can be set as the parameter 604 in the fifth functional block 600e “dehydrate”. A clothing, stylish clothing, dirty clothing, and sweater can be set as the consumer products used 602, and the time and temperature can be set as the parameter 604 in the sixth functional block 600F “dry”. Further, each consumer product 620 is linked with rule information 622. A detailed description of the rule information 622 will be given later. The functional block sequence 610 stored in block DB 460 is not limited to that of FIG. 7. Reference is made back to FIG. 6.

The communication unit 410 communicates with the appliance 100, the sensor 200, and the terminal 500 via the network 300. For example, the communication unit 410 receives the sensor information 54 from the sensor 200 and receives the user control information 58 from the appliance 100. The second acquisition unit 442 of the processing unit 420 receives the sensor information 54 from the communication unit 410. In the case the sensor information 54 is an image, the second acquisition unit 442 recognizes the detail of action executed by the user 10 in the appliance 100 and the consumer product 620 used in the action by the user 10 by subjecting the image to an image recognition process. For example, the detail action of the user 10 inputting the consumer product 620 (detergent, clothing, sweater) to the washing machine is recognized. In this process, one consumer product 620 is associated with one detail of action such as inputting a sweater (consumer product) to a washing machine or inputting a detergent (consumer product) to a tank. When the sensor information 54 is metadata, on the other hand, the second acquisition unit 442 omits the image recognition process. As a result, the second acquisition unit 442 acquires action information indicating the detail of action and the consumer product 620.

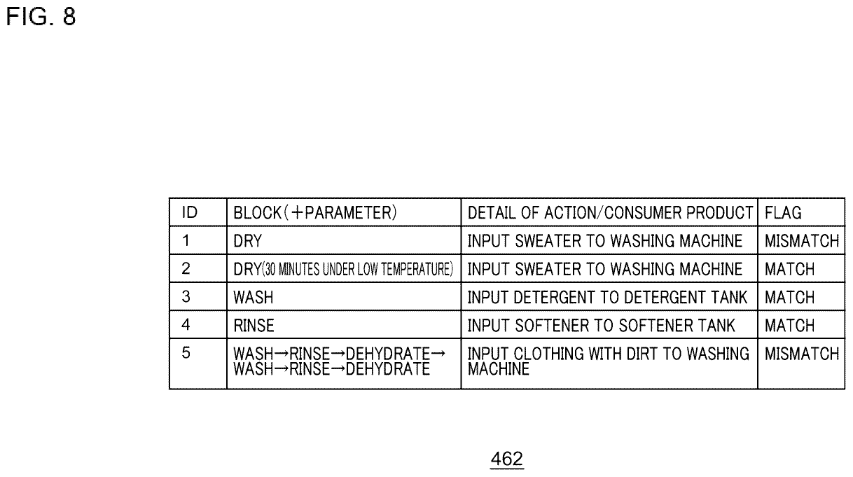

The second acquisition unit 442 acquires rule information indicating whether the detail of action included in the action information matches the functional block 600 from the rule information DB 462. FIG. 8 shows a data structure of the rule information DB 462. This shows the rule information defined for the functional block 600 in the functional block sequence 610 of FIG. 7. “ID” denotes a number that makes rule information identifiable. “Block” denotes the functional block 600, and parameter information may be stored as well. “Detail of action/consumer product” denotes a combination of the detail of action by the user and the consumer product 620 and is indicated by the above-described action information. A match “flag”, also called match information, indicates, for each functional block 600, that the detail of action and the functional block 600 match. Alternatively, the match flag may indicate, for each functional block 600, that the detail of action and a parameter presented by the functional block 600 match. In the case the user has not performed an action corresponding to the match flag, it is necessary to delete or modify the functional block 600. A mismatch “flag”, also called mismatch information, indicates, for each functional block 600, that the detail of action and the functional block 600 do not match. In the case the user has performed an action corresponding to the mismatch flag, it is necessary to delete or modify the functional block 600.

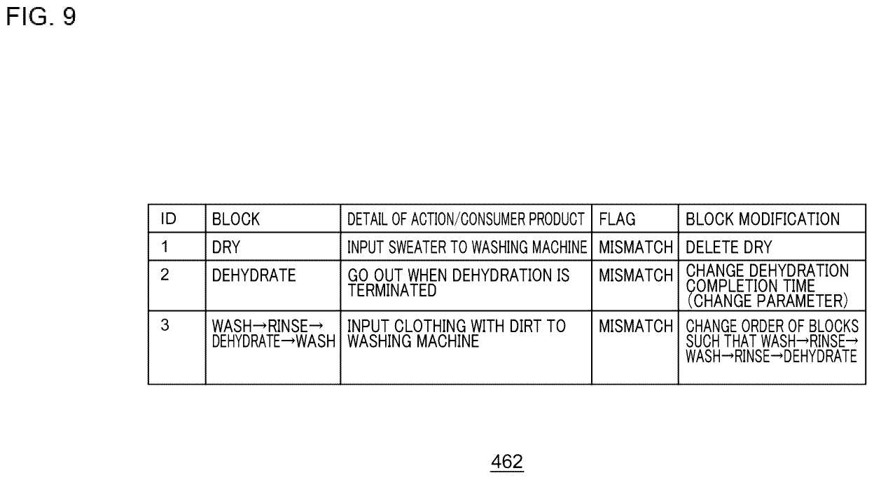

Thus, the rule information is information indicating, for each combination of the consumer product 620 and the functional block 600, an action that the user should perform, an action that the user should not perform, the consumer product 620 that should not be used, and a parameter defined for each consumer product 620. FIG. 9 shows another data structure of the rule information DB 462. “Block modification” denotes the detail of deletion or modification required when it is determined that deletion or modification of the functional block 600 is necessary. Reference is made back to FIG. 6.

The first acquisition unit 440 receives the user control information 58 from the communication unit 410. As described above, the user control information 58 includes the detail of the user control 56 performed by the user 10 such as identification information on the functional block sequence 610. The identification information on the functional block sequence 610 is identification information on the functional block sequence 610 scheduled to be executed by the appliance 100. The first acquisition unit 440 acquires the functional block sequence 610 from the block DB 460 based on the identification information on the functional block sequence 610.

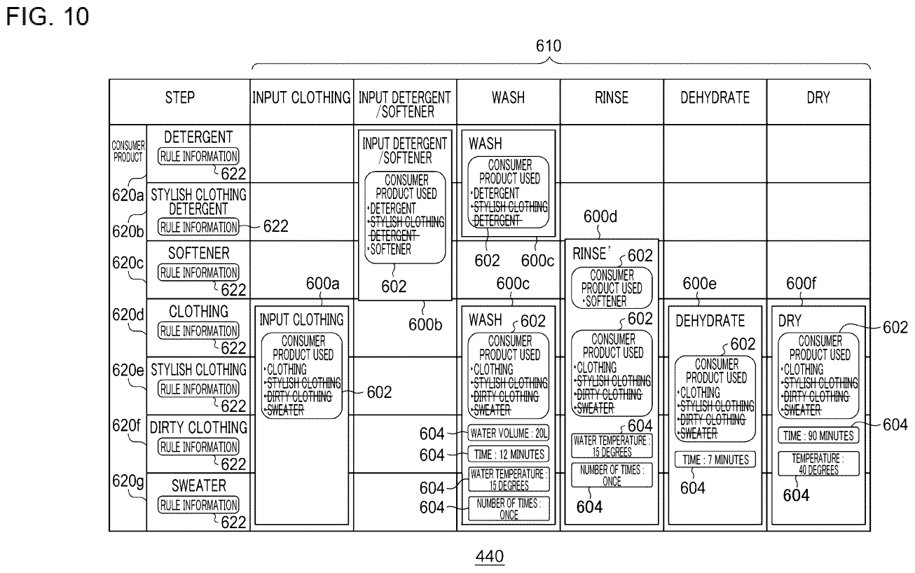

FIG. 10 shows an overview of a process executed by the first acquisition unit 440. This shows the functional block sequence 610 similar to that of FIG. 7 wherein the consumer product used 602 or the parameter 604 corresponding to the identification information on the functional block sequence 610 are selected. In this case, the user is using the “recommended course” for washing in the washing machine so that the consumer product 602 or the parameter 604 corresponding to the functional block sequence 610 of the course are selected. For example, only the clothing among the consumer products used 602 is selected, and the stylish clothing, dirty clothing, and sweater are deleted in the first functional block 600a. Further, the detergent and clothing among the consumer products used 602 are selected, and the stylish clothing detergent, stylish clothing, dirty clothing, and sweater are deleted in the third functional block 600c. Further, the water volume: 20 L, the time: 12 minutes, the water temperature: 15 degrees, and the number of times: once are set as the parameters 604 in the third functional block 600c. The also applies to the other functional blocks 600.

Further, in the case the user selects a “stylish clothing course” in the washing machine, the fifth consumer product 620e “stylish clothing” and the second consumer product 620b “stylish clothing detergent” are selected as the consumer product used 602. Further, the consumer product used 602 and the parameter 604 in the functional block 600 following the third functional block 600c “wash” that are relevant to the stylish clothing course are similarly selected. Reference is made back to FIG. 6.

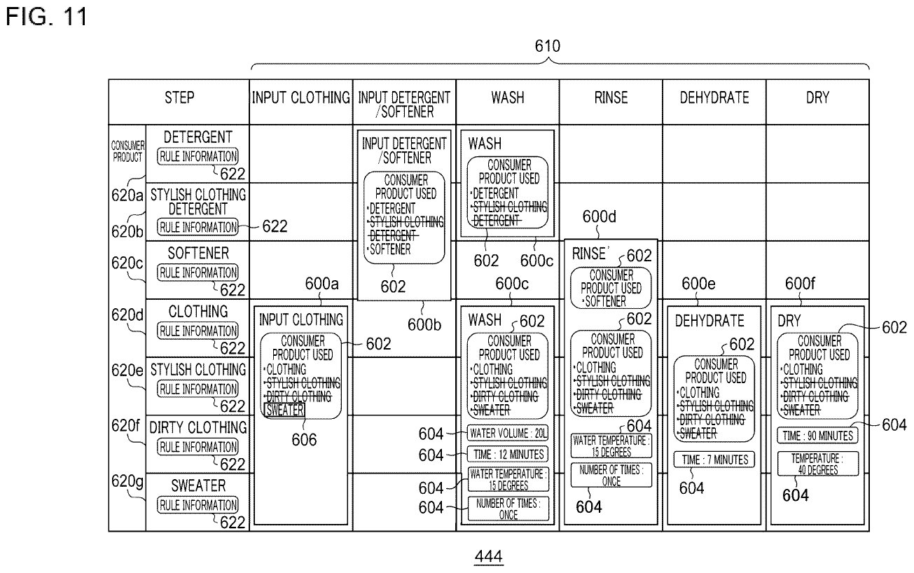

The first processing unit 444 causes the detail of action or the consumer product 620 included in the action information to be reflected in the functional block sequence 610. FIG. 11 shows an overview of a process executed by the first processing unit 444. This is shown in the same manner as the functional block sequence 610 of FIG. 10. Since the detail of action of the user 10 inputting also a sweater to the washing machine and the consumer product 620 are shown in the action information, the first processing unit 444 checks the sweater, i.e., the consumer product used 602 in the first functional block 600a, as an additional item 606. Reference is made back to FIG. 6.

On the other hand, the rule information on the functional block 600 has already been acquired. When the first processing unit 444 determines that the detail of action presenting a match flag is not included in the user's action information, the first processing unit 444 determines to modify or delete the functional block 600 associated with the match flag. Further, the first processing unit 444 determine to modify or delete the functional block 600 associated with the match flag also when the first processing unit 444 determines that the parameter of the functional block 600 presenting a match flag is not set. This corresponds to addressing the case in which the user has not performed the action of the match flag by deleting/modifying the functional block 600 so that a match flag is set. For example, a modification is made to flush water in the softener tank at the time of the functional block 600 of “wash”, in the case the user has not input the detergent to the detergent tank but has input it to the softener tank.

When the first processing unit 444 determines that the detail of action presenting a mismatch flag is included in the user's action information, on the other hand, the first processing unit 444 determines to modify or delete the functional block 600 associated with the mismatch flag. This corresponds to addressing the case in which the user has performed the action of the mismatch flag by modifying/deleting the functional block 600 with reference to the rule information DB 462 so that a match flag is set. For example, in the case the user has input a sweater to the washing machine in the presence of a drying block, the drying block may be deleted, or the parameter is changed to the one of ID “2” of FIG. 8 for which the match flag is set, because a mismatch flag is identified. Alternatively, the functional block 600 may be modified or deleted according to the block modification of FIG. 9.

When the first processing unit 444 determines that there is a functional block 600 in the original functional block sequence 610 that does not match the action information by referring to the rule information, the second processing unit 446 creates a new functional block sequence 610 in which the functional block 600 is modified or deleted. When the original functional block sequence 610 is referred to as the “first functional block sequence”, the new functional block sequence 610 is referred to as the “second functional block sequence”. In the second functional block sequence, all functional blocks 600 match the action. By modifying the functional block sequence 610 based on a modification detail like this, the execution of the functional block sequence 610 that could produce a result different from the result expected at the end of the step due to an action taken by the user can be avoided, and the functional block sequence 610 that produces the same or similar result as the originally expected result can be executed. The detail of modification is not limited thereto.

When the first processing unit 444 determines that the detail of action of the user 10 matches the functional block sequence 610, the output unit 448 transmits information for causing the appliance 100 to execute the operation indicated by the user control information 58 to the appliance 100 via the communication unit 410 and the network 300. When a new functional block sequence 610 is created by the second processing unit 446, on the other hand, the output unit 448 transmits information on the new functional block sequence 610 to the appliance 100 via the network 300 as the suggested modification information 60.

Upon receiving the suggested modification information 60, the appliance 100 confirms with the user 10 whether to adopt the new functional block sequence 610, by displaying the detail of the new functional block sequence 610 on the display unit. Further, when the appliance 100 receives the suggested modification information 60, the appliance 100 may adopt the new functional block sequence 610 without requesting confirmation and display “the functional block sequence has been modified” on the display unit. When the user 10 designed the initial functional block sequence 610 by himself/herself, for example, confirmation from the user 10 is requested. When the user 10 selects user control information such as the “recommended course”, however, confirmation from the user 10 is not required.

The output unit 448 may transmit the suggested modification information 60 to the terminal 500 via the network 300. Upon receiving the suggested modification information 60, the terminal 500 confirms with the user 10 whether to adopt the new functional block sequence 610, by displaying the detail of the new functional block sequence 610 on the display unit.

The features are implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

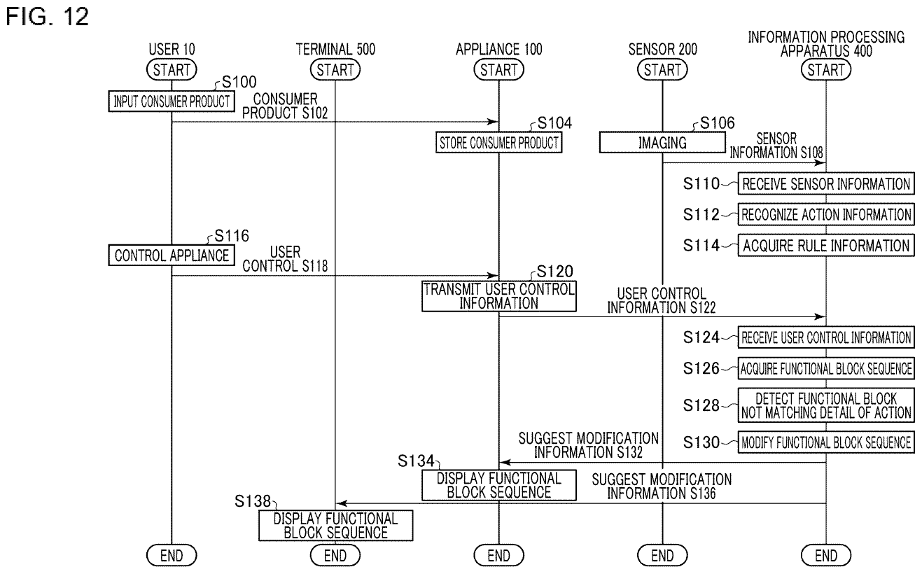

The operation of the information processing system 1000 according to the above configuration will be described. FIG. 12 is a sequence chart showing a sequence of steps for modifying a functional block sequence executed by the information processing system 1000. The user 10 inputs the consumer product 620 to the appliance 100 (S100, S102). The appliance 100 stores the consumer product 620 (S104). The sensor 200 captures an image of the input of the consumer product 620 to the appliance 100 by the user 10 (S106). The sensor 200 transmits the sensor information 54 to the information processing apparatus 400 (S108). When the information processing apparatus 400 receives the sensor information 54 (S110), the information processing apparatus 400 recognizes the action information (S112) and acquires the rule information (S114).

The user 10 executes user control on the appliance 100 (S116), and the appliance 100 receives the user control (S118). The appliance 100 transmits the user control information 58 to the information processing apparatus 400 (S120, S122). When the information processing apparatus 400 receives the user control information 58 (S124), the information processing apparatus 400 acquires the functional block sequence 610 (S126). The information processing apparatus 400 detects the functional block 600 that does not match the detail of action (S128). The information processing apparatus 400 modifies the functional block sequence 610 (S130). The information processing apparatus 400 transmits the suggested modification information 60 to the appliance 100 (S132), and the appliance 100 displays the functional block sequence 610 (S134). The information processing apparatus 400 transmits the suggested modification information 60 to the terminal 500 (S136), and the terminal 500 displays the functional block sequence 610 (S138).

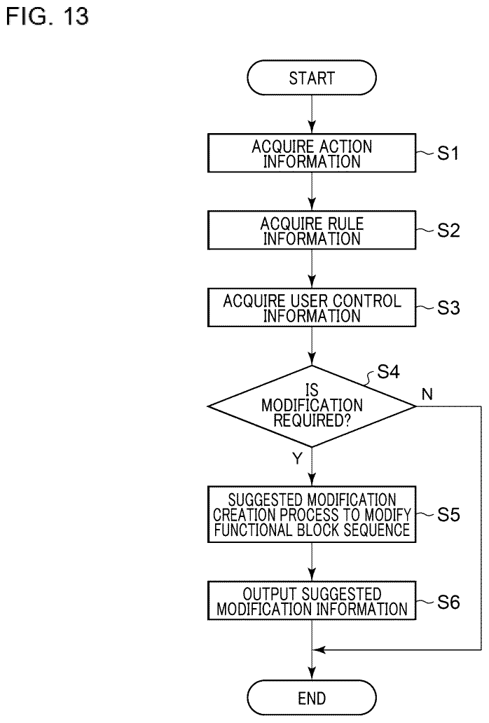

FIG. 13 is a flowchart showing a sequence of steps for modifying a functional block sequence executed by the information processing apparatus 400. The second acquisition unit 442 acquires the action information (S1) and acquires the rule information (S2). The first acquisition unit 440 acquires the user control information 58 (S3). When a modification of the functional block sequence 610 is required (Y in S4), the second processing unit 446 executes a suggested modification creation process to modify the functional block sequence 610 (S5). The output unit 448 outputs the suggested modification information 60 (S6). When a modification of the functional block sequence 610 is not required (N in S4), the process is terminated.

### Variation 1

In the embodiment, it is assumed that the user 10 inputs a sweater to the washing machine. In the first variation, another case is assumed. For example, a case where the user 10 mistakenly inputs the detergent instead of the softener or vice versa. The washing machine is provided with a detergent input port and a softener input port separately, and the user 10 should input the detergent to the detergent input port and input the softener to the softener input port. In variation 1, however, the user 10 inputs the softener to the detergent input port and inputs the detergent to the softener input port. The information processing system 1000 modifies the step in response to such a contradictory action.

The sensor 200 of FIG. 5 images the action of the user 10 inputting the softener to the detergent input port of the appliance 100 (washing machine) and inputting the detergent to the softener input port. The sensor 200 transmits the image capturing an action of the user 10 as the sensor information 54 to the information processing apparatus 400 via the network 300. The sensor information 54 transmitted from the network 300 may include metadata resulting from the image recognition process by the sensor 200. The appliance 100 receives the user control 56 from the user 10 as in the above. The appliance 100 transmits the detail of the user control 56 performed by the user 10, e.g., the identification information on the functional block sequence, to the information processing apparatus 400 as the user control information 58.

The communication unit 410 of the information processing apparatus 400 receives the sensor information 54 from the sensor 200 and receives the user control information 58 from the appliance 100. When the second acquisition unit 442 of the processing unit 420 receives the sensor information 54 from the communication unit 410, the second acquisition unit 442 subjects the image in the sensor information 54 to an image recognition process. As a result, the second acquisition unit 442 recognizes the detail of action and the consumer product 620 of the action of the user 10 inputting the softener to the detergent input port and inputting the detergent to the softener input port. When the sensor information 54 transmitted from the sensor 200 includes metadata, the image recognition process in the second acquisition unit 442 is omitted.

The second acquisition unit 442 acquires the rule information corresponding to the consumer product 620 included in the action information from the rule information DB 462. When the consumer product 620 included in the action information are the detergent and the softener, the second acquisition unit 442 acquires the rule information on the first consumer product 620a and the rule information on the third consumer product 620c in FIG. 8.

The first acquisition unit 440 receives user control information 58 from the communication unit 410. The first acquisition unit 440 acquires the functional block sequence 610 from the block DB 460 based on the identification information on the functional block sequence 610 included in the user control information 58. The functional block sequence 610 acquired is shown as FIG. 10.

The first processing unit 444 causes the detail of action or the consumer product 620 included in the action information to be reflected in the functional block sequence 610. Since the detail of action and the consumer product 602 of the action of the user 10 inputting the softener to the detergent input port and inputting the detergent to the softener input port are indicated in the action information, the first processing unit 444 checks the detergent and the softener, i.e., the consumer product used 602 in the second functional block 600b.

On the other hand, the rule information on the consumer product 620 indicated in the action information has already been acquired. As in the above, the first processing unit 444 determines to modify or delete the functional block 600 when the first processing unit 444 determines that the detail of action presenting a match flag is not included in the user's action information or when the first processing unit 444 determines that the parameter of the functional block 600 presenting a match flag is not set. Meanwhile, the first processing unit 444 determines to modify or delete the functional block 600 when the first processing unit 444 determines that the detail of action presenting a mismatch flag is included in the action information. In this case, it is determined that the detail of action does not match “input detergent to detergent tank” of ID “3” and “input softener to softener tank” of ID “4” in FIG. 8.

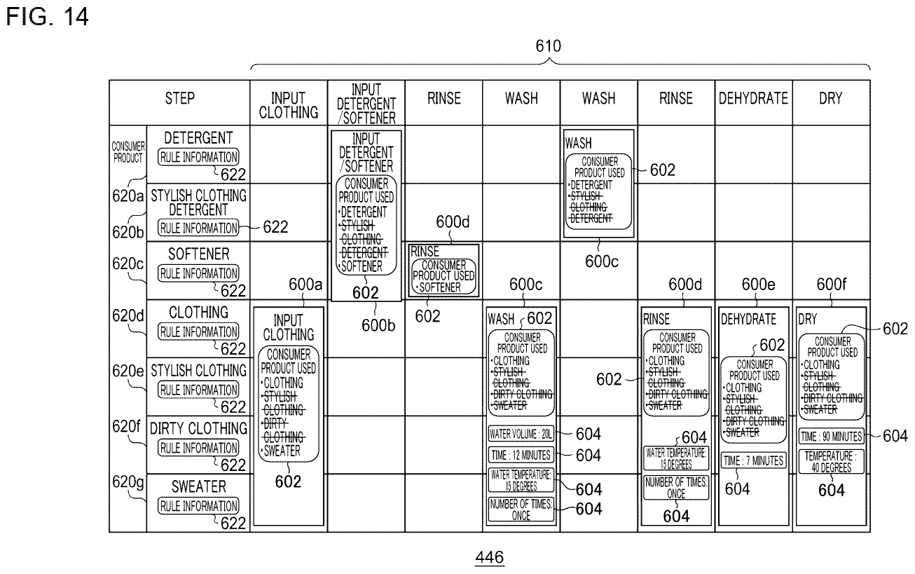

When it is determined that there is a functional block 600 that does not match the action information, the first processing unit 444 modifies the functional block 600. FIG. 14 shows an overview of a process executed by the first processing unit 444. In the original functional block sequence 610, the second functional block 600b is followed by the third functional block 600c, the fourth functional block 600d, and the fifth functional block 600e. This is modified by the first processing unit 444 such that the fourth functional block 600d, the third functional block 600c, the third functional block 600c, the fourth functional block 600d, and the fifth functional block 600e are arranged after the second functional block 600b. In the fourth functional block 600d after the second functional block 600b, an action of dissolving the detergent input to the softener input port is executed, and, in the third functional block 600c after the fourth functional block 600d, an action of washing the clothing is executed. Further, in the third functional block 600c after the third functional block 600c, an action of dissolving the softener input to the detergent input port is performed, and, in the fourth functional block 600d after the third functional block 600c, a rinsing action is performed. Since the operation following this is the same as before, the explanation is omitted here.

### Variation 2

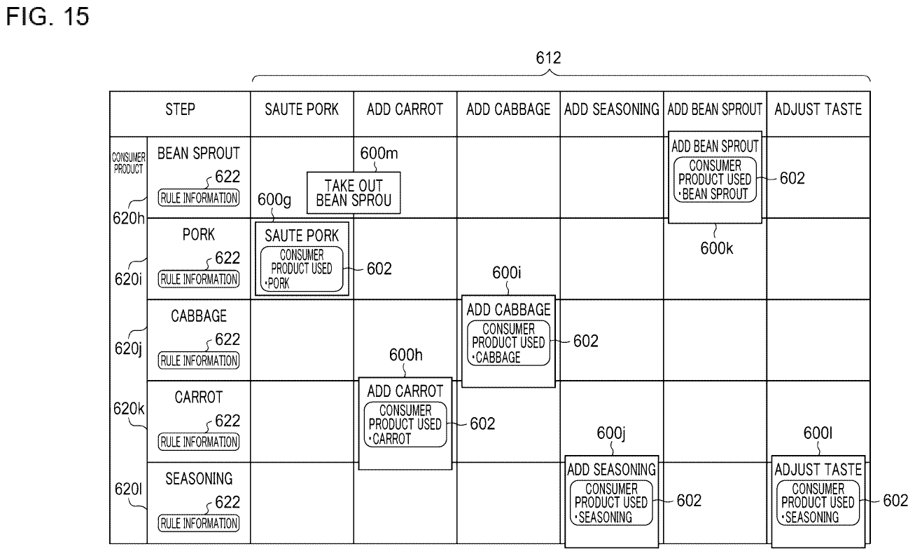

So far, the washing step has been described, but the cooking step will be described in variation 2. FIG. 15 shows a configuration of the functional block sequence 612 used in the cooking step to cook sauteed vegetables. In the functional block sequence 612, a seventh functional block 600g to a twelfth functional block 600l, collectively referred to as the functional block 600, are arranged in this order. The seventh functional block 600g to the twelfth functional block 600l correspond to the functions “saute pork”, “add carrot”, “add cabbage”, “add seasoning”, “add bean sprout”, and “adjust taste”, respectively. The functional block sequences 612 other than the thirteenth functional block 600m are stored in block DB 460.

An eighth consumer product 620h to a twelfth consumer product 620l are shown as the consumer product 620 that can be used in the functional block sequence 612. The eighth consumer product 620h is “bean sprout”, the ninth consumer product 620i is “pork”, the tenth consumer product 620j is “cabbage”, the eleventh consumer product 620k is “carrot”, and the twelfth consumer product 620l is “seasoning”. The consumer product used 602 or the parameter 604 can be set in each functional block 600. For example, pork can be set as the consumer product used 602 in the seventh functional block 600g “saute pork”. Further, each consumer product 620 is linked with the rule information 622. The functional block sequence 612 stored in block DB 460 is not limited to that of FIG. 15.

The sensor 200 of FIG. 5 images an action of the user 10 adding the bean sprout when pork should be sauteed. The sensor 200 transmits the image capturing an action of the user 10 as the sensor information 54 to the information processing apparatus 400 via the network 300. The sensor information 54 transmitted from the network 300 may include metadata resulting from the image recognition process by the sensor 200. The appliance 100 or the terminal 500 transmits information indicating selection of sauteed vegetables as the user control information 58 to the information processing apparatus 400.

The communication unit 410 of the information processing apparatus 400 receives the sensor information 54 from the sensor 200 and the user control information 58 from the appliance 100 or terminal 500. When the second acquisition unit 442 of the processing unit 420 receives the sensor information 54 from the communication unit 410, the second acquisition unit 442 executes subjects the image in the sensor information 54 to an image recognition process. As a result, the second acquisition unit 442 recognizes the detail of action and the consumer product 620 of the action of the user 10 adding the bean sprout when pork should be sauteed. When the sensor information 54 transmitted from the sensor 200 includes metadata, the image recognition process in the second acquisition unit 442 is omitted.

The second acquisition unit 442 acquires the rule information corresponding to the consumer product 620 included in the action information from the rule information DB 462. The rule information includes, for example, match flags indicating that a mistake should not be made in the cooking ingredient to input (e.g., sugar and salt should not be mistaken), a mistake should not be made in the order of inputting cooking ingredients, and a mistake should not be made in the manner of cutting the cooking ingredient (e.g., the cooking ingredient should not be shredded mistakenly instead of being chopped into wedges).

The first acquisition unit 440 receives the user control information 58 from the communication unit 410. The first acquisition unit 440 acquires the functional block sequence 612 from the block DB 460 based on the user control information 58. The functional block sequence 612 acquired is shown as FIG. 15.

The first processing unit 444 causes the detail of action or the consumer product 620 included in the action information to be included in the functional block sequence 612. Since the detail of action and the consumer product 620 of the action of the user adding the bean spout when pork should be sauteed are indicated in the action information, the first processing unit 444 checks the bean sprout, i.e., the consumer product used 602 in the eleventh functional block 600k.

Meanwhile, the rule information on the consumer product 620 indicated in the action information has already been acquired. By executing the same process as in the above, the first processing unit 444 confirms, for example, that the detail of action of the user 10 does not match the match flag “a mistake should not be made in the order of inputting cooking ingredients”.

When it is determined that there is a functional block 600 that does not match the action information, the first processing unit 444 modifies the functional block 600. Referring to FIG. 15, the thirteenth functional block 600m “take out bean sprout” is added between the seventh functional block 600g and the eighth functional block 600h. Even if the user 10 mistakenly adds the bean sprout first, such a modification avoids cooking sauteed vegetables in which the texture of the bean sprout is lost, by causing the bean sprout to be taken out temporarily in the middle of cooking.

Another example of modification in the cooking step is as follows. If the user 10 mistakenly adds salt instead of sugar, the functional block sequence 612 is modified so that the amount (parameter) of all ingredients matches the amount of salt added by mistake. If the user 10 mistakenly adds minced meat when a curry should be made, the functional block sequence 612 is modified so that the dish being cooked will be a dry curry (a dish in which minced meat is used). If the user 10 makes a mistake in the manner of cutting the onion and shreds the onion instead of chopping it into wedges, the functional block sequence 612 is modified to cook a menu that uses a shredded onion.

### Variation 3

As described above, the information processing apparatus 400 according to variation 3 creates a new functional block sequence 610 by modifying or deleting the functional block 600. The functional block sequence 610 may be the functional block sequence 612 but will be generically referred to as the “functional block sequence 610” for clarity. Variation 3 relates to a case where the user 10 executes a new functional block sequence 610, but the execution result is unsatisfactory. The information processing system 1000 and the information processing apparatus 400 according to variation 3 are of the same type as those of FIGS. 5 and 6. In this section, we will focus on the differences from the above.

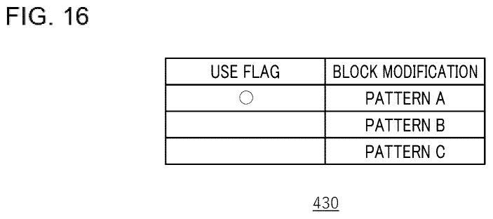

As described above, the first processing unit 444 of the information processing apparatus 400 modifies the functional block 600 using the rule information DB 462 shown in FIG. 9, and the second processing unit 446 creates a new functional block sequence 610 based on the functional block 600 modified. In this case, it is assumed that the first processing unit 444 modifies the functional block 600 according to the rule information of ID “2” in FIG. 9. That is, a block modification “change dehydration completion time (change parameter)” is performed on the functional block 600. A block modification such as this can be changed. FIG. 16 shows a data structure of a table stored in the storage unit 430. For example, “pattern A”, “pattern B”, and “pattern C” are prepared in advance as a block modification, and “pattern A”, in which a use flag is set, is used. Therefore, “pattern A” corresponds to “change dehydration completion time (change parameter)”. A table as shown in FIG. 16 may be prepared for each ID in FIG. 9.

The terminal 500 receives the suggested modification information 60 indicating the new functional block sequence 610. The suggested modification information 60 also includes identification information on the new functional block sequence 610. The terminal 500 acquires the new functional block sequence 610 and the identification information on the new functional block sequence 610 based on the suggested modification information 60 received. After causing the appliance 100 to execute the new functional block sequence 610, the user 10 can use the terminal 500 to input an evaluation on the execution result of the new functional block sequence 610. Evaluation is, for example, indicated by either satisfaction or dissatisfaction. The terminal 500 transmits a combination of the identification information and evaluation on the new functional block sequence 610 (hereinafter referred to as “evaluation information”) to the information processing apparatus 400 via the network 300.

The communication unit 410 of the information processing apparatus 400 receives the evaluation information from the terminal 500. The communication unit 410 outputs the evaluation information to the first processing unit 444.

When the evaluation in the evaluation information is satisfaction, the first processing unit 444 does not change the detail of block modification in the rule information DB 462 corresponding to the identification information. For example, pattern A is maintained. When the evaluation in the evaluation information is dissatisfaction, on the other hand, the first processing unit 444 changes the detail of block modification in the rule information DB 462 corresponding to the identification information. For example, the first processing unit 444 changes pattern A to pattern B. In this way, evaluation by the user 10 is fed back to the block modification.

The evaluation may not only indicate satisfaction or dissatisfaction but may also indicate a reason for dissatisfaction such as insufficient drying. The first processing unit 444 modifies the block to extend the drying time based on the reason for dissatisfaction.

According to this embodiment, the functional block sequence 610 is modified when the functional block sequence 610 scheduled to be executed by the appliance 100 does not match the action information. Therefore, the step can be modified when a result different from the result expected at the end of the step could be produced due to an action taken by the user. Further, the functional block 600 is modified when the functional block sequence 610 is modified so that the parameter can be changed. Further, the action information is acquired based on the sensor information received from the sensor 200 so that the action of the user 10 can be grasped. Further, the sensor information is an image captured by the sensor 200 so that the action of the user 10 can be accurately grasped by an image recognition process. Further, the sensor information includes metadata resulting from subjecting the image to an image recognition process in the sensor 200 so that the action of the user 10 can be accurately grasped. Further, the consumer product 620 used in the action by the user 10 is also indicated in the action information so that misuse of the consumer product 620 can be recognized by the user 10.

Further, when the detail of action does not match the rule information, it is determined that there is a functional block 600 that does not match the action information so that the determination can be made easily. Further, when a mandatory action in the functional block 600 is not indicated in the detail of action, it is determined that there is a functional block 600 that does not match the action information so that a mandatory action can be used for determination. Further, when a prohibited action in the functional block 600 is indicated in the detail of action, it is determined that there is a functional block 600 that does not match the action information so that a prohibited action can be used for determination. Further, when the value of a parameter prohibited in the functional block 600 is presented by the detail of action, it is determined that there is a functional block 600 that does not match the action information. Therefore, the value of a parameter can be used for determination.

Further, the functional block 600 that does not match the action information is deleted so that the functional block sequence 610 that matches the action information can be created. Further, the parameter set in the functional block 600 that does not match the action information is changed so that the functional block sequence 610 that matches the action information can be created. Further, the functional block 600 that does not match the action information is replaced by another functional block 600 so that the functional block sequence 610 that matches the action information can be created. Further, the order of the functional blocks 600 included in the functional block sequence 610 is changed so that the functional block sequence 610 that matches the action information can be created.

Further, the evaluation on the execution result of the new functional block sequence 610 is fed back to the information processing apparatus 400 so that modification or deletion of the functional block 600 according to the evaluation by the user 10 can be executed. Further, modification or deletion of the functional block 600 according to the evaluation by the user 10 is executed so that the functional block sequence 610 that increases user satisfaction can be created.

A summary of an embodiment of the present disclosure is given below. An information processing method according to an embodiment of the present disclosure includes: acquiring, as a first block sequence, a block sequence comprised of a plurality of blocks each defined in a functional unit executable by an appliance and arranged in an order of operation, the block sequence being scheduled to be executed by the appliance; acquiring action information indicating a detail of action executed by a user in the appliance; and outputting a second block sequence created by modifying or deleting a block included in the first block sequence and not matching the action information.

The acquiring of the action information may acquire the action information based on sensor information received from a sensor.

The sensor may be an imaging apparatus, and the sensor information may include an image captured by the imaging apparatus or result information resulting from subjecting the image to recognition.

The action information may include a consumer product used in an action by the user.

The method further includes acquiring rule information indicating whether the detail of action and the block match, wherein the rule information is referred to, and a block, of the blocks included in the first block sequence, that does not match the action information is modified or deleted to create the second block sequence.

The rule information may include match information indicating, for each block, that the detail of action and the block match. A determination may be made that the detail of action presenting the match information corresponding to a given block included in the first block sequence is not included in the action information on the user, and the given block may be modified or deleted.

The rule information may include mismatch information indicating, for each block, that the detail of action and the block do not match. A determination may be made that the detail of action presenting the mismatch information corresponding to a given block included in the first sequence is included in the action information on the user, and the given block may be modified or deleted.

The rule information may include match information indicating, for each block, that the detail of action and a parameter presented by the block match. A determination may be made that a parameter of a block presenting the match information corresponding to a given block included in the first block sequence is not set, and the given block is modified or deleted.

The block that does not match the action information may be deleted in the second block sequence.

A parameter set in the block that does not match the action information may be changed in the second block sequence.

The block that does not match the action information may be replaced by another block in the second block sequence.

An order of a block included in the first block sequence may be changed in the second block sequence.

Another embodiment of the present disclosure relates to an information processing apparatus. The apparatus includes: a first acquisition unit that acquires, as a first block sequence, a block sequence comprised of a plurality of blocks each defined in a functional unit executable by an appliance and arranged in an order of operation, the block sequence being scheduled to be executed by the appliance; a second acquisition unit that acquires action information indicating a detail of action executed by a user in the appliance; and an output unit that outputs a second block sequence created by modifying or deleting a block included in the first block sequence and not matching the action information.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

A sensor different from an imaging apparatus may be used as the sensor 200 according to the embodiment. That sensor also transmits the sensor information 54 to the information processing apparatus 400. According to this variation, the flexibility of the configuration can be improved.

What is claimed is:

1. An information processing method comprising:
acquiring, as a first block sequence, a block sequence comprised of a plurality of blocks each defined in a functional unit executable by an appliance and arranged in an order of operation, the block sequence being scheduled to be executed by the appliance;
acquiring action information indicating a detail of action executed by a user in the appliance; and
outputting a second block sequence created by modifying or deleting a block included in the first block sequence and not matching the action information.

2. The information processing method according to claim 1,
wherein the acquiring of the action information acquires the action information based on sensor information received from a sensor.

3. The information processing method according to claim 2,
wherein the sensor is an imaging apparatus, and
wherein the sensor information includes an image captured by the imaging apparatus or result information resulting from subjecting the image to recognition.

4. The information processing method according to claim 1,
wherein the action information includes a consumer product used in an action by the user.

5. The information processing method according to claim 4, further comprising:
acquiring rule information indicating whether the detail of action and the block match,
wherein the rule information is referred to, and a block, of the blocks included in the first block sequence, that does not match the action information is modified or deleted to create the second block sequence.

6. The information processing method according to claim 5,
wherein the rule information includes match information indicating, for each block, that the detail of action and the block match,
wherein a determination is made that the detail of action presenting the match information corresponding to a given block included in the first block sequence is not included in the action information on the user, and
wherein the given block is modified or deleted.

7. The information processing method according to claim 5,
wherein the rule information includes mismatch information indicating, for each block, that the detail of action and the block do not match,
wherein a determination is made that the detail of action presenting the mismatch information corresponding to a given block included in the first sequence is included in the action information on the user, and
wherein the given block is modified or deleted.

8. The information processing method according to claim 5,
wherein the rule information includes match information indicating, for each block, that the detail of action and a parameter presented by the block match,
wherein a determination is made that a parameter of a block presenting the match information corresponding to a given block included in the first block sequence is not set, and
wherein the given block is modified or deleted.

9. The information processing method according to claim 1,
wherein the block that does not match the action information is deleted in the second block sequence.

10. The information processing method according to claim 1,
wherein a parameter set in the block that does not match the action information is changed in the second block sequence.

11. The information processing method according to claim 1,
wherein the block that does not match the action information is replaced by another block in the second block sequence.

12. The information processing method according to claim 1,
wherein an order of the block included in the first block sequence is changed in the second block sequence.

13. An information processing apparatus comprising:
a first acquisition unit that acquires, as a first block sequence, a block sequence comprised of a plurality of blocks each defined in a functional unit executable by an appliance and arranged in an order of operation, the block sequence being scheduled to be executed by the appliance;
a second acquisition unit that acquires action information indicating a detail of action executed by a user in the appliance; and
an output unit that outputs a second block sequence created by modifying or deleting a block included in the first block sequence and not matching the action information.

14. A program comprising computer-implemented modules including:
a module that acquires, as a first block sequence, a block sequence comprised of a plurality of blocks each defined in a functional unit executable by an appliance and arranged in an order of operation, the block sequence being scheduled to be executed by the appliance;
a module that acquires action information indicating a detail of action executed by a user in the appliance; and
a module that outputs a second block sequence created by modifying or deleting a block included in the first block sequence and not matching the action information.
